(19) United States
(12) Patent Application Publication
(10) Pub. No.: US 2026/0285394 A1
(43) Pub. Date: Sep. 24, 2026

(54) ELECTRIC STEERING COLUMN AND VEHICLE HAVING THE SAME

(71) Applicant: HL MANDO CORPORATION, Pyeongtaek-si (KR)

(72) Inventor: Sangchul KU, Pyeongtaek-si (KR)

(21) Appl. No.: 19/577,020

(22) Filed: Mar. 24, 2026

(30) Foreign Application Priority Data
Mar. 24, 2025 (KR) 10-2025-0037346
Mar. 23, 2026 (KR) 10-2026-0051564

(51) Int. Cl. B62D 5/04; B62D 1/19; B62D 5/00

(52) U.S. Cl. CPC B62D 5/0403; B62D 1/19; B62D 5/006; B62D 5/0409; B62D 5/0445

(57) ABSTRACT

The present embodiment relates to an electric steering column and a vehicle having the same. More specifically, it is possible to provide an electric steering column and a vehicle having the same, which can minimize motor output and reduce operating noise by reducing friction during forward and backward movement of a steering wheel, and can improve movement stability of the steering wheel by securing rigidity in up-down and left-right directions.

### CROSS REFERENCE TO RELATED APPLICATION

This application claims priority from Korean Patent Application Nos. 10-2025-0037346, filed on Mar. 24, 2025 and 10-2026-0051564, filed on Mar. 23, 2026, which are hereby incorporated by reference for all purposes as if fully set forth herein.

### BACKGROUND

### Field

The present embodiments relate to an electric steering column and a vehicle having the same, in which friction is reduced and operational stability is improved in a structure for moving a steering wheel.

### Description of Related Art

Generally, a steering column of an automobile is a device for a driver to control a traveling direction of a vehicle by manipulating a steering wheel.

Conventional steering apparatuses were of a type in which a steering wheel and wheels are mechanically connected to transmit a steering force, but recently, a Steer-By-Wire (SBW) type electric steering apparatus, which removes the mechanical connection between the steering wheel and the wheels and controls steering by an electrical signal, is being developed.

An electric steering column comprises a telescopic function for adjusting a position of a steering wheel in a forward-backward direction to suit a height or body type of a driver, and a tilt function for adjusting an angle in an up-down direction.

Through these functions, the driver can adjust a protrusion degree and a tilt angle of the steering wheel to suit his or her height or body type, thereby enabling smooth steering manipulation.

A conventional telescopic function has a structure in which a support bracket moves along a guide surface of a mounting bracket in a sliding friction manner.

In this case, a contact area between the support bracket and the guide surface is wide, resulting in large friction resistance, and there is a problem that an output of a motor for telescopic driving must be increased.

In addition, there was a problem that contact noise due to sliding friction occurs, thereby deteriorating operational quality.

At this time, the steering column has a structure in which components of considerable weight, such as a steering wheel and a reaction force driving unit excluding a mounting bracket, must be transported, and thus a transport load is large and friction resistance is accumulated, requiring a large motor output and causing noise during operation.

In particular, there is a problem that movement stability of the steering wheel is deteriorated because rigidity in up-down and left-right directions is not sufficient.

### SUMMARY

The present embodiments can provide an electric steering column and a vehicle having the same, which can minimize motor output and reduce operational noise by reducing friction during forward-backward movement of a steering wheel, and can improve movement stability of the steering wheel by securing rigidity in up-down and left-right directions.

In one aspect, the present embodiments may provide an electric steering column comprising: a mounting bracket fixed to a vehicle body, having an accommodating space formed therein, and having a guide part formed on one side or both sides of the accommodating space in a width direction and extending in a steering wheel direction or an opposite direction; a support bracket contacting the guide part in a rolling friction manner, and installed in the accommodating space of the mounting bracket to be movable in the steering wheel direction or the opposite direction; an outer tube in which an inner tube supporting rotation of a steering shaft is installed to be insertable or protrudable, and supported by the support bracket; and a tilting bracket installed between the support bracket and the outer tube to perform a tilting operation of the steering wheel.

In another aspect, the present embodiments may provide a vehicle comprising: an electric steering column rotatably supporting the steering wheel and comprising a reaction force driving unit generating a steering reaction force torque corresponding to manipulation of a steering wheel and providing the steering reaction force torque to a steering shaft rotating together with the steering wheel during rotation of the steering wheel; a steering driving unit mechanically separated from the steering shaft and changing a steering angle of a wheel based on an electrical signal; and a controller controlling the reaction force torque of the reaction force driving unit and a steering operation of the steering driving unit based on steering input information of the steering wheel and driving state information of the vehicle, wherein the electric steering column comprises: a mounting bracket fixed to a vehicle body, having an accommodating space formed therein, and having a guide part formed on one side or both sides of the accommodating space in a width direction and extending in a steering wheel direction or an opposite direction; a support bracket contacting the guide part in a rolling friction manner, and installed in the accommodating space of the mounting bracket to be movable in the steering wheel direction or the opposite direction; an outer tube supported by the support bracket, wherein an inner tube supporting rotation of the steering shaft is installed to be insertable into or protrudable from the outer tube; and a tilting bracket installed between the support bracket and the outer tube to perform a tilting operation of the steering wheel.

According to the present embodiments, it is possible to provide an electric steering column and a vehicle having the same, which can minimize motor output and reduce operating noise by reducing friction during forward and backward movement of a steering wheel, and can improve movement stability of the steering wheel by securing rigidity in up-down and left-right directions.

### BRIEF DESCRIPTION OF THE DRAWINGS

The present disclosure will be more fully understood from the detailed description provided below and the accompanying drawings, and the detailed description and the accompanying drawings are provided for the purpose of explanation only and do not limit the content of the present disclosure.

FIG. 1 is a view schematically illustrating a structure of a steer-by-wire steering column of a vehicle.

FIGS. 2 and 3 are perspective views illustrating an electric steering column according to the present embodiment.

FIG. 4 is an exploded perspective view illustrating the electric steering column according to the present embodiment.

FIG. 5 is a front view illustrating the electric steering column according to the present embodiment.

FIG. 6 is a plan view illustrating the electric steering column according to the present embodiment.

FIG. 7 is a side cross-sectional view illustrating a cross section taken along line A-A′ of FIG. 6.

FIG. 8 is a front cross-sectional view illustrating a cross section taken along line B-B′ of FIG. 6.

FIG. 9 is a front cross-sectional view illustrating a cross section taken along line C-C′ of FIG. 6.

FIGS. 10 and 11 are side views illustrating an operating state of the electric steering column according to the present embodiment.

FIGS. 12 and 13 are perspective views illustrating a part of the electric steering column according to the present embodiment.

### DETAILED DESCRIPTION

In the following description of examples or embodiments of the present disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the present disclosure, detailed descriptions of well-known functions and components incorporated herein will be omitted when it is determined that the description may make the subject matter in some embodiments of the present disclosure rather unclear. The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the disclosure. Each of these terms is not used to define essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

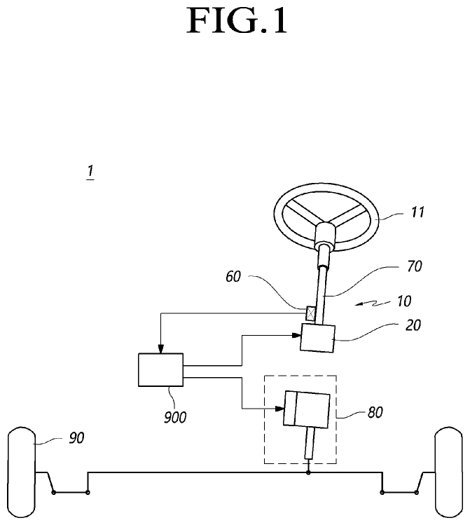

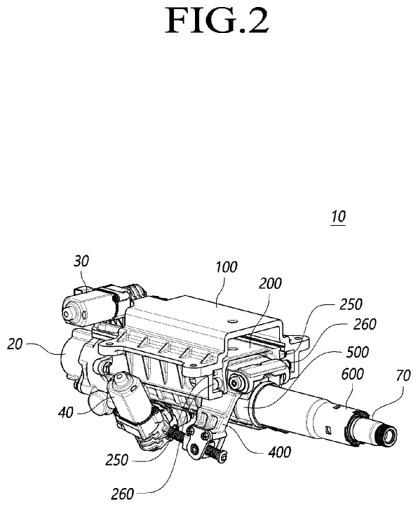

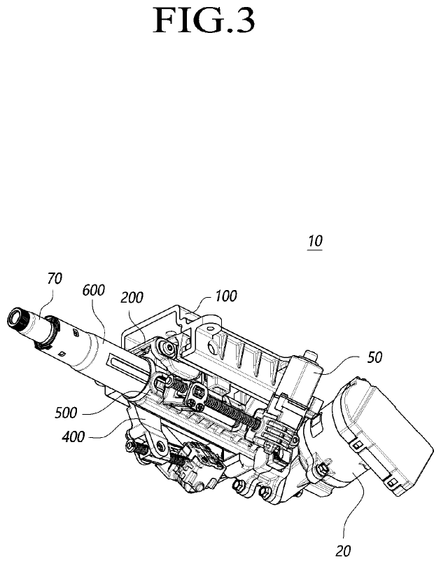

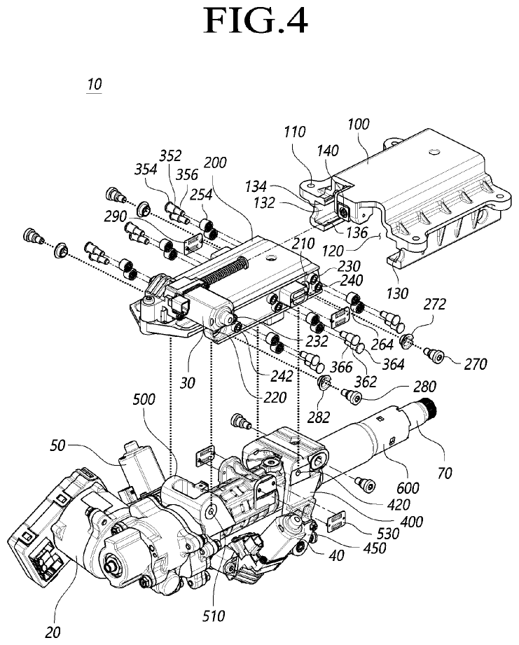

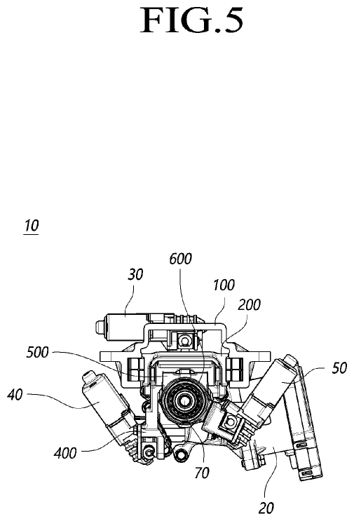

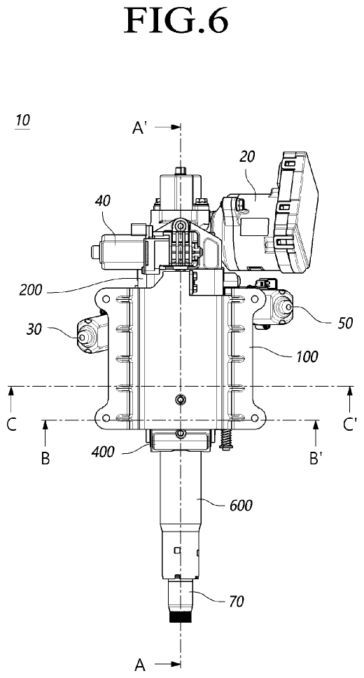

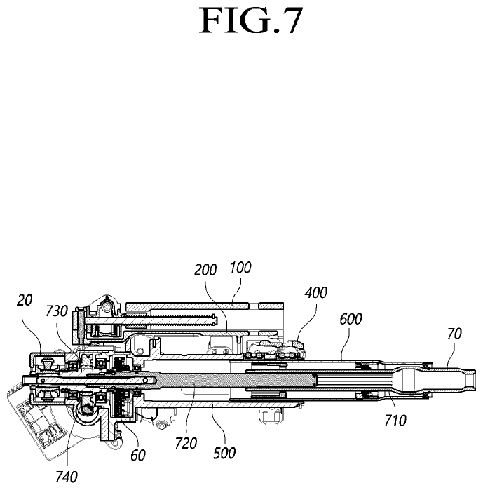

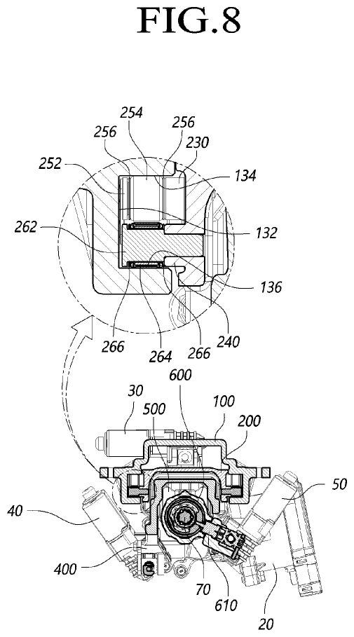

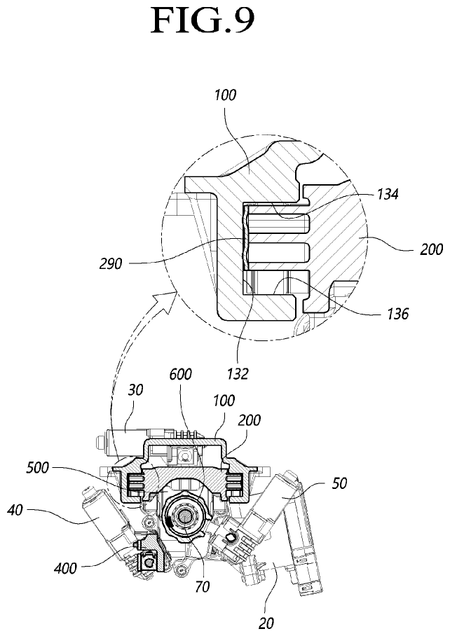

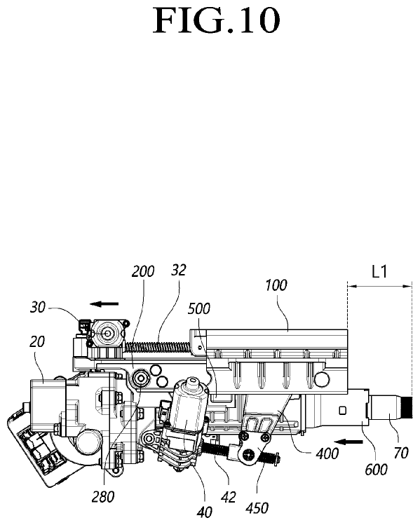

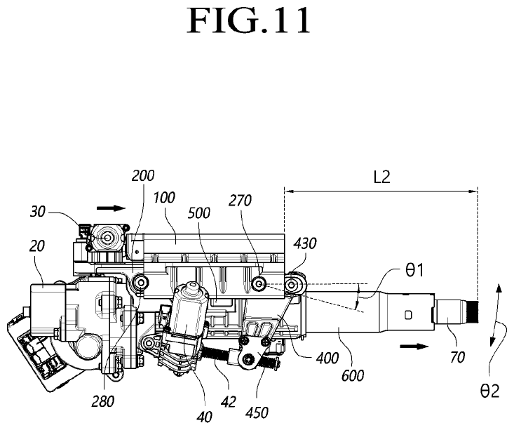

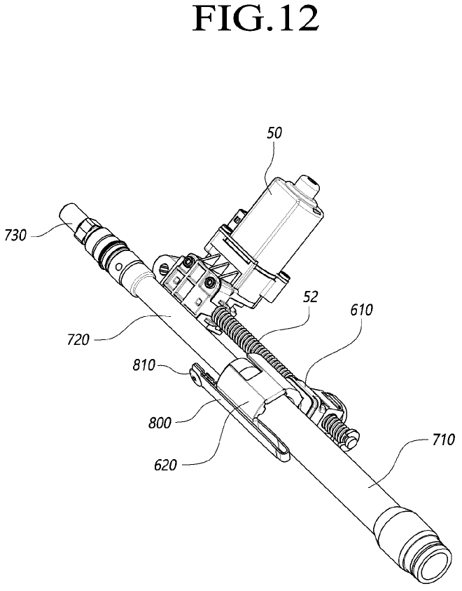

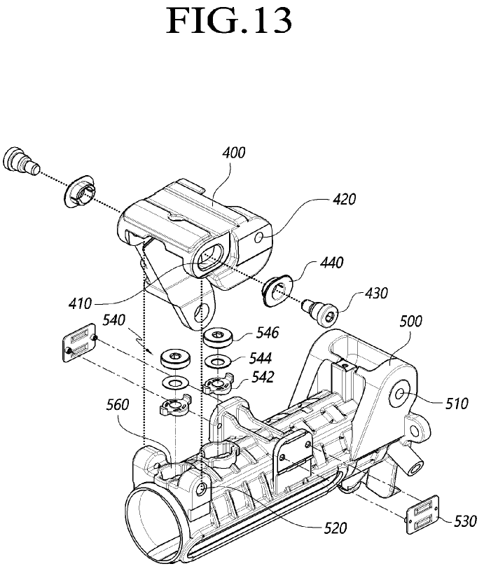

FIG. 1 is a diagram schematically illustrating a structure of a steer-by-wire steering column of a vehicle, FIGS. 2 and 3 are perspective views illustrating an electric steering column according to an embodiment, FIG. 4 is an exploded perspective view illustrating an electric steering column according to an embodiment, FIG. 5 is a front view illustrating an electric steering column according to an embodiment, FIG. 6 is a plan view illustrating an electric steering column according to an embodiment, FIG. 7 is a side cross-sectional view illustrating a cross-section taken along line A-A′ of FIG. 6, FIG. 8 is a front cross-sectional view illustrating a cross-section taken along line B-B′ of FIG. 6, FIG. 9 is a front cross-sectional view illustrating a cross-section taken along line C-C′ of FIG. 6, FIGS. 10 and 11 are side views illustrating an operating state of an electric steering column according to an embodiment, and FIGS. 12 and 13 are perspective views illustrating a part of an electric steering column according to an embodiment.

A vehicle according to the present embodiments comprises an electric steering column 10 rotatably supporting a steering wheel 11 and comprising a reaction force driving unit 20 that generates a steering reaction force torque corresponding to manipulation of the steering wheel 11 and provides the steering reaction force torque to a steering shaft 70 rotating together with the steering wheel 11 during rotation of the steering wheel 11; a steering driving unit 80 mechanically separated from the steering shaft 70 and changing a steering angle of a wheel 90 based on an electrical signal; and a controller 900 that controls the reaction force torque of the reaction force driving unit 20 and a steering operation of the steering driving unit 80 based on steering input information of the steering wheel 11 and driving state information of the vehicle.

Hereinafter, a vehicle comprising an electric steering column according to the present embodiments will be described in detail with reference to the accompanying drawings.

In the present embodiment, a steering wheel direction is defined as a front side, and an opposite direction is defined as a rear side for description.

That is, a side where the steering wheel is disposed, where a driver is located, is defined as the front side, and a side where the reaction force driving unit is disposed is defined as the rear side.

Therefore, movement of each component of the electric steering column in the steering wheel direction or toward the front side means movement in a direction closer to the driver, and movement in the opposite direction or toward the rear side means movement in a direction away from the driver.

In addition, the width direction means a left-right direction perpendicular to a front-rear direction, and an up-down direction means a direction perpendicular to both the front-rear direction and the width direction.

The steering wheel 11 serves to transmit an operating force of a driver to the steering shaft 70, and provides steering input information for rotational input to the controller 900 via the steering shaft 70.

The controller 900 controls the reaction force driving unit 20 based on the steering input information to generate an appropriate steering reaction force torque on the steering shaft 70, and controls the steering driving unit 80 to change the steering angle of the wheel 90.

The controller 900 comprehensively analyzes various driving state information such as steering torque detected from a torque sensor 60, speed of a vehicle 1, and acceleration, to perform optimal steering control.

The steering shaft 70 comprises an input shaft 710, an intermediate shaft 720, a reaction force transmission shaft 730, and a torsion bar 740, and rotates together with the steering wheel 11 during rotation of the steering wheel 11.

The input shaft 710 is rotatably supported by the inner tube 600, a front side thereof is connected to the steering wheel 11, and a rear side thereof is connected to the intermediate shaft 720.

The intermediate shaft 720 is rotatably supported by the outer tube 500, a front side thereof is connected to the input shaft 710, and a rear side thereof is connected to the reaction force transmission shaft 730.

The reaction force transmission shaft 730 is connected to the intermediate shaft 720 via a torsion bar 740 and transmits a reaction force motor output of the reaction force driving unit 20 to the intermediate shaft 720.

The torque sensor 60 detects a relative rotational displacement between the intermediate shaft 720 and the reaction force transmission shaft 730 generated by twisting of a torsion bar 740 elastically connecting the intermediate shaft 720 and the reaction force transmission shaft 730, and transmits the detected relative rotational displacement to the controller 900.

The reaction force driving unit 20 provides a steering reaction force to the steering wheel 11 through the steering shaft 70.

The reaction force driving unit 20 generates a steering reaction force torque corresponding to manipulation of the steering wheel 11 and provides it to the steering shaft 70, thereby providing an appropriate steering feel to a driver.

The steering driving unit 80 is mechanically separated from the steering shaft 70 and changes a steering angle of a wheel 90 based on an electrical signal of the controller 900.

The controller 900 can change a traveling direction of the vehicle 1 by controlling the steering driving unit 80.

The controller 900 controls a reaction force torque of the reaction force driving unit 20 and a steering operation of the steering driving unit 80 based on steering input information of the steering wheel 11 and driving state information of the vehicle 1.

In the present embodiment, a Steer-By-Wire (SBW) method where the steering shaft 70 and the steering driving unit 80 are mechanically separated is mainly described, however, a structure in which the steering shaft 70 and the steering driving unit 80 are mechanically connected is also possible.

An electric steering column according to the present embodiment comprises a mounting bracket 100 fixed to a vehicle body of a vehicle 1, having an accommodating space 120 formed therein, and having a guide part 130 formed on one side or both sides of the accommodating space 120 in a width direction and extending in a steering wheel 11 direction or an opposite direction; a support bracket 200 contacting the guide part 130 in a rolling friction manner, and installed in the accommodating space 120 of the mounting bracket 100 to be movable in the steering wheel direction or the opposite direction; an outer tube 500 in which an inner tube 600 supporting rotation of a steering shaft 70 is installed to be insertable or protrudable, and supported by the support bracket 200; and a tilting bracket 400 installed between the support bracket 200 and the outer tube 500 to perform a tilting operation of the steering wheel 11.

The mounting bracket 100 is fixed to a vehicle body and supports the support bracket 200, the tilting bracket 400, the outer tube 500, and the inner tube 600.

An accommodating space 120 is formed inside the mounting bracket 100, and a guide part 130 extending in a steering wheel direction or an opposite direction is formed on one side or both sides of the accommodating space 120 in a width direction.

The mounting bracket 100 has a plurality of fastening holes 110 into which bolts or the like are inserted, and can maintain a state of being fixed to a vehicle body by bolts inserted into the fastening holes 110 and coupled to the vehicle body.

And, a guide part 130 extending in a steering wheel direction or an opposite direction is formed on both sides of the accommodating space 120 in a width direction.

The guide part 130 may be formed on one side or the other side of the accommodating space 120 in the width direction, or may be formed on both sides.

The guide part 130 comprises a first guide surface 132 formed in the accommodating space 120 toward the width direction, a second guide surface 134 formed on an upper side of the first guide surface 132 toward an opposite direction to a vehicle body coupling side, and a third guide surface 136 formed on a lower side of the first guide surface 132 to face the second guide surface 134.

The first guide surface 132 is formed on both sides of the accommodating space 120 in the width direction to face each other, and the first sliding bushing 290 contacts the first guide surface 132.

A plurality of first moving support parts 250 contact the second guide surface 134 while rolling thereon.

The second guide surface 134 extends in the steering wheel direction or the opposite direction to guide movement of the first moving support parts 250.

A plurality of second moving support parts 260 contact the third guide surface 136 while rolling thereon.

The third guide surface 136 extends in the steering wheel direction or the opposite direction to guide movement of the second moving support parts 260.

The second guide surface 134 and the third guide surface 136 are disposed to face each other, so that vertical rigidity can be secured during movement of the support bracket 200.

That is, since the first moving support part 250 and the second moving support part 260 are always in contact with the second guide surface 134 and the third guide surface 136, respectively, vertical shaking of the support bracket 200 can be prevented.

In the present embodiment, the electric steering column 10 further comprises a first actuator 30 coupled to the support bracket 200, and a first screw 32 that is rotated in one direction or an opposite direction by the first actuator 30, is coupled to a first screw coupling part 140 installed at an end of the mounting bracket 100, and moves the support bracket 200 in a steering wheel direction or an opposite direction.

The first actuator 30 may be a pneumatic, hydraulic, or electric motor, and rotates the first screw 32 in one direction or the opposite direction according to a control signal received from a controller 900.

The first screw 32 may be formed as a ball screw or a lead screw, and may be screw-coupled to the first screw coupling part 140 to convert rotational motion into linear motion.

The first screw coupling part 140 is installed at a rear end of the mounting bracket 100, and the first screw 32 is coupled thereto.

Accordingly, the support bracket 200 moves toward a front side or a rear side if the first screw 32 rotates in one direction or the opposite direction.

The support bracket 200 contacts the guide part 130 in a rolling friction manner, and is installed in the accommodating space 120 of the mounting bracket 100 to be movable in the steering wheel direction or the opposite direction.

The support bracket 200 moves toward the front side or the rear side by the first actuator 30, and moves the steering wheel 11 toward the front side or the rear side.

Thereby, a telescopic function for adjusting a front-rear direction position of the steering wheel 11 can be implemented.

The support bracket 200 is installed in the accommodating space 120 of the mounting bracket 100 to be movable in a front-rear direction.

On both sides of the support bracket 200, a first support hole 210, a second support hole 220, a plurality of first support parts 230, and a plurality of second support parts 240 are respectively formed.

The first support hole 210 is formed on a front side of the support bracket 200, the second support hole 220 is formed on a rear side of the support bracket 200, a plurality of first support parts 230 are formed on an upper side of the second support parts 240, and a plurality of second support parts 240 are formed on a lower side of the first support parts 230.

The first support hole 210 is formed on both sides of the support bracket 200 in a width direction, respectively, and a first coupling member 270 coupled to a first coupling hole 420 of the tilting bracket 400 is inserted or coupled thereto.

The first coupling member 270 supports a tilting operation of the steering shaft 70.

The second support hole 220 is formed on both sides of the support bracket 200 in a width direction, respectively, and a second coupling member 280 coupled to a second coupling hole 510 of the outer tube 500 is inserted or coupled thereto.

The second coupling member 280 fixes the outer tube 500 to the support bracket 200.

In this embodiment, a friction reducing member 272 is provided in a bushing form between the first support hole 210 and the first coupling member 270, and a friction reducing member 282 is provided in a bushing form between the second support hole 220 and the second coupling member 280.

A plurality of first support parts 230 are formed on both sides of the support bracket 200 in a width direction, spaced apart in a front-rear direction, and a first moving support part 250 is coupled thereto.

In the first support part 230, a first fitting hole 232 is formed, into which an insertion part 356 of a first support member 252 is inserted or coupled.

A plurality of second support parts 240 are formed on both sides of the support bracket 200 in a width direction, spaced apart in a front-rear direction, and a second moving support part 260 is coupled thereto.

In the second support part 240, a second fitting hole 242 is formed, into which an insertion part 366 of a second support member 262 is inserted or coupled.

In this embodiment, a plurality of first moving support parts 250 and a plurality of second moving support parts 260 are respectively formed on both sides of the support bracket 200 in a width direction.

Thereby, the electric steering column 10 can distribute a load of the support bracket 200 and can stably move the support bracket 200.

The first moving support part 250 contacts the second guide surface 134 in a vehicle body coupling side direction while rolling thereon.

More specifically, the first moving support part 250 comprises a first support member 252 coupled to the support bracket 200, a first rolling contact member 254 installed on the first support member 252 and contacting the second guide surface 134 while rolling thereon, and a first friction reducing member 256 disposed between the first rolling contact member 254 and a separation prevention part 354 of the first support member 252 or between the first rolling contact member 254 and the support bracket 200, and reducing friction during rotation of the first rolling contact member 254.

The first support member 252 is coupled to a first fitting hole 232, rotatably supports the first rolling contact member 254, and at the same time, prevents separation of the first rolling contact member 254.

The first support member 252 comprises a support shaft part 352 rotatably supporting the first rolling contact member 254, a separation prevention part 354 extending from one side or the other side of the support shaft part 352 in an enlarged-diameter shape and preventing separation of the first rolling contact member 254, and an insertion part 356 extending from an opposite side of the support shaft part 352, on which the separation prevention part 354 is formed, in a reduced-diameter shape and coupled to the first fitting hole 232 of the support bracket 200.

The support shaft part 352 may be formed in a cylindrical or columnar shape for rotatably supporting the first rolling contact member 254, and the first rolling contact member 254 is coupled in a ring shape to an outer side of the support shaft part 352 and rotates by balls or rollers performing a rolling motion.

The separation prevention part 354 is formed in an expanded diameter and extended shape on one side or the other side of the support shaft part 352, and prevents separation of the first rolling contact member 254.

The separation prevention part 354 is formed in a shape with a larger diameter than the support shaft part 352, and prevents the first rolling contact member 254 from coming off in an axial direction.

The insertion part 356 extends in a reduced diameter shape on an opposite side of the support shaft part 352 where the separation prevention part 354 is formed, and is coupled to the first fitting hole 232.

The insertion part 356 is formed in a shape with a smaller diameter than the support shaft part 352, and is coupled to the first fitting hole 232 of the first support part 230.

The first rolling contact member 254 is installed on the first support member 252, and contacts the second guide surface 134 while rolling thereon.

The first rolling contact member 254 may be formed as a cylindrical roller or bearing that contacts the second guide surface 134 facing an opposite direction to the vehicle body coupling side while rolling thereon.

The first friction reducing member 256 is disposed between the first rolling contact member 254 and the separation prevention part 354 of the first support member 252 or between the first rolling contact member 254 and the support bracket 200, and reduces friction during rotation of the first rolling contact member 254.

That is, the first friction reducing member 256 reduces friction between the first rolling contact member 254 and the separation prevention part 354 or between the first rolling contact member 254 and the support bracket 200 during rotation of the first rolling contact member 254, and prevents left-right movement of the first rolling contact member 254, thereby preventing a decrease in operating force.

Such a first friction reducing member 256 may be formed in a washer shape, and may be formed of a low-friction plastic material such as polyamide (PA) or polyacetal (POM), to reduce a friction coefficient of a contact surface during rotation of the first rolling contact member 254.

The second moving support part 260 contacts the third guide surface 136 formed to face the second guide surface 134 while rolling thereon.

More specifically, the second moving support part 260 comprises a second support member 262 coupled to the support bracket 200, a second rolling contact member 264 installed on the second support member 262 and contacting the third guide surface 136 while rolling thereon, and a second friction reducing member 266 disposed between the second rolling contact member 264 and a separation prevention part 364 of the second support member 262 or between the second rolling contact member 264 and the support bracket 200 to reduce friction during rotation of the second rolling contact member 264. The second support member 262 is coupled to a second fitting hole 242, rotatably supports the second rolling contact member 264, and at the same time, prevents separation of the second rolling contact member 264.

The second support member 262 comprises a support shaft part 362 rotatably supporting the second rolling contact member 264, a separation prevention part 364 extending in an expanded diameter shape on one side or the other side of the support shaft part 362 and preventing separation of the second rolling contact member 264, and an insertion part 366 extending in a reduced diameter shape on an opposite side of the support shaft part 362 where the separation prevention part 364 is formed and coupled to the second fitting hole 242 of the support bracket 200.

The support shaft part 362 may be formed in a cylindrical or columnar shape to rotatably support the second rolling contact member 264, and the second rolling contact member 264 is coupled to an outside of the support shaft part 362 in a ring shape and rotated by balls or rollers performing a rolling motion.

The separation prevention part 364 is formed in an expanded diameter and extended shape on one side or the other side of the support shaft part 362 to prevent separation of the second rolling contact member 264.

The separation prevention part 364 is formed in a shape having a larger diameter than the support shaft part 362 and prevents the second rolling contact member 264 from being detached in an axial direction.

The insertion part 366 extends in a reduced diameter shape on the opposite side of the support shaft part 362 where the separation prevention part 364 is formed, and is coupled to the second fitting hole 242.

The insertion part 366 is formed in a shape having a smaller diameter than the support shaft part 362 and is coupled to the second fitting hole 242 of the second support part 240.

The second rolling contact member 264 is installed on the second support member 262 and contacts the third guide surface 136 to perform rolling movement.

The second rolling contact member 264 may be formed as a cylindrical roller or a bearing that contacts the third guide surface 136 facing toward a vehicle body coupling side and performs rolling movement.

The second friction reducing member 266 is disposed between the second rolling contact member 264 and the separation prevention part 364 of the second support member 262 or between the second rolling contact member 264 and the support bracket 200 to reduce friction during rotation of the second rolling contact member 264.

That is, the second friction reducing member 266 is disposed between the second rolling contact member 264 and the separation prevention part 364 or between the second rolling contact member 264 and the support bracket 200 if the second rolling contact member 264 rotates, thereby reducing friction during rotation of the second rolling contact member 264.

The second friction reducing member 266 reduces friction between the second rolling contact member 264 and the separation prevention part 364 or between the second rolling contact member 264 and the support bracket 200 if the second rolling contact member 264 rotates, and prevents left and right movement of the second rolling contact member 264 to prevent a decrease in operating force.

The second friction reducing member 266 may be formed in a washer shape and may be formed of a low-friction plastic material such as polyamide (PA) or polyacetal (POM) to reduce a friction coefficient of a contact surface during rotation of the second rolling contact member 264.

The outer tube 500 is supported by the support bracket 200, the inner tube 600 is installed on a front side to be insertable or protrudable, and the reaction force driving unit 20 is installed on a rear side.

The outer tube 500 moves in a front-rear direction together with the support bracket 200 and performs a tilting operation by the tilting bracket 400.

A second coupling hole 510 to which the second coupling member 280 is coupled is formed on the rear side of the outer tube 500, and a third coupling hole 520 to which the support shaft member 430 is coupled is formed on the front side.

The second coupling holes 510 are respectively formed on both sides of the outer tube 500 in the width direction, and the second coupling member 280 passing through a second support hole 220 of the support bracket 200 is coupled thereto.

The outer tube 500 rotates about the second coupling member 280 and performs a tilting operation of the steering shaft 70.

Third coupling holes 520 are respectively formed on both sides of the outer tube 500 in the width direction, and the support shaft members 430 passing through insertion holes 410 of the tilting bracket 400 are coupled thereto.

The inner tube 600 supports rotation of the steering shaft 70, and is inserted into the outer tube 500 or protruded from the outer tube 500 by the third actuator 50 to adjust an additional forward-backward position of the steering wheel 11.

At this time, a holder part 540 supporting the inner tube 600 is coupled to a through hole 560 of the outer tube 500, and the holder part 540 presses the inner tube 600 with a predetermined pressure and supports the inner tube 600.

The holder part 540 comprises a pressing member 542, a washer 544, and a fastening bolt 546, and the pressing member 542 presses the inner tube 600 with a predetermined pressure by fastening of the fastening bolt 546 to fix a position of the inner tube 600.

The third screw coupling part 610 is coupled to the third screw 52, and moves the inner tube 600 toward a front side or a rear side if the third screw 52 rotates in one direction or an opposite direction.

The third screw coupling part 610 is disposed outside the inner tube 600 and coupled to the inner tube support part 620 disposed inside the inner tube 600, and supports the inner tube 600.

Subsequently, the electric steering column 10 comprises the second actuator 40 coupled to the outer tube 500 and a second screw 42 rotated in one direction or an opposite direction by the second actuator 40, coupled to the second screw coupling part 450 installed at an end of the tilting bracket 400 to perform a tilting operation, and rotating the tilting bracket 400 to perform the tilting operation.

The second actuator 40 may be a pneumatic, hydraulic, or electric motor, and rotates the second screw 42 in one direction or an opposite direction according to a control signal received from the controller 900.

The second screw 42 may be formed as a ball screw or a lead screw, and may be screw-coupled to the second screw coupling part 450 to convert rotational motion into angular motion.

The second screw 42 is rotated in one direction or an opposite direction by the second actuator 40, and is coupled to the second screw coupling part 450 installed at the end of the tilting bracket 400 to perform the tilting operation.

The tilting bracket 400 is installed between the support bracket 200 and the outer tube 500 and performs the tilting operation of the steering wheel 11.

The tilting bracket 400 rotates about the first coupling member 270 by the second actuator 40 and performs the tilting operation of the steering wheel 11.

The tilting bracket 400 rotates about the first coupling member 270 if the second screw 42 rotates in one direction or an opposite direction and performs the tilting operation.

Through this, a tilt function for adjusting an up-down direction angle of the steering wheel 11 may be implemented.

The tilting bracket 400 has the insertion holes 410 into which the support shaft members 430 are inserted and the first coupling holes 420 to which the first coupling members 270 are coupled formed therein.

The insertion holes 410 are formed on both sides of the tilting bracket 400 in the width direction, and the support shaft members 430 coupled to the third coupling holes 520 of the outer tube 500 are respectively inserted into the insertion holes 410.

The first coupling holes 420 are rotation centers of the tilting bracket 400 and are formed on both sides of the tilting bracket 400 in the width direction, and the first coupling members 270 pass through the first support holes 210 of the support bracket 200 and are respectively coupled to the first coupling holes 420.

The support shaft member 430 connects the outer tube 500 and the tilting bracket 400, and supports the tilting bracket 400 so that the tilting bracket 400 performs a tilting operation.

A friction reducing member 440 is inserted into the insertion hole 410 to support rotation of the support shaft member 430, and reduces friction of the support shaft member 430 if the support shaft member 430 rotates.

In the present embodiment, the friction reducing member 440 may be formed as a bearing or a bushing, and supports rotation of the support shaft member 430.

The second screw coupling part 450 is installed at a lower end of the tilting bracket 400, and the second screw 42 is coupled thereto.

Continuing, the electric steering column 10 comprises the third actuator 50 coupled to the outer tube 500, and the third screw 52 rotated in one direction or an opposite direction by the third actuator 50, coupled to the third screw coupling part 610 installed on the inner tube 600, and moving the inner tube 600 in the steering wheel 11 direction or an opposite direction.

The third actuator 50 may be a pneumatic, hydraulic, or electric motor, and rotates the third screw 52 in one direction or an opposite direction according to a control signal received from the controller 900.

The third screw 52 may be formed as a ball screw or a lead screw, and may be screw-coupled with the third screw coupling part 610 to convert rotational motion into linear motion.

The third screw 52 is rotated in one direction or an opposite direction by the third actuator 50, and is coupled to the third screw coupling part 610 installed on the inner tube 600 to move the inner tube 600 in the steering wheel direction or an opposite direction.

Accordingly, the inner tube 600 protrudes from the outer tube 500 if the third screw 52 rotates in one direction, and is inserted into the outer tube 500 if the third screw 52 rotates in the opposite direction, so that additional forward-backward position adjustment of the steering wheel 11 is possible.

That is, the inner tube 600 moves to the front side or the rear side by the third actuator 50, and moves the steering wheel 11 to the front side or the rear side.

Through this, a telescopic function for adjusting a forward-backward position of the steering wheel 11 may be implemented.

The third screw coupling part 610 is coupled with the third screw 52, and moves the steering wheel 11 to the front side or the rear side if the third screw 52 rotates in one direction or an opposite direction.

In the present embodiment, the electric steering column 10 comprises the inner tube support part 620 disposed inside the inner tube 600, coupled to the third screw coupling part 610 disposed outside the inner tube 600, and fixes the inner tube 600 to the third screw coupling part 610.

The inner tube support part 620 is disposed inside the inner tube 600, is coupled to the third screw coupling part 610 disposed outside the inner tube 600, and fixes the inner tube 600 to the third screw coupling part 610.

A third screw coupling part 610 is disposed on an outer side of the inner tube 600, and an inner tube support part 620 is disposed on an inner side of the inner tube 600, and the third screw coupling part 610 presses the inner tube 600 and is coupled to the inner tube support part 620.

The inner tube support part 620 moves the steering wheel 11 to a front side or a rear side together with the third screw coupling part 610 if a third screw 52 rotates in one direction or an opposite direction.

Here, the electric steering column 10 further comprises a shock absorbing member 800 coupled to the inner tube 600, extending toward the steering wheel 11 and bent from the steering wheel 11 direction toward an opposite direction to the steering wheel 11 to surround the inner tube support part 620, to absorb a shock while being plastically deformed such that a bent portion is unfolded by the inner tube support part 620 by moving together with the inner tube 600 during a collision of a vehicle 1.

The shock absorbing member 800 is coupled to the inner tube 600, extends in the steering wheel 11 direction, and is formed in a shape bent from the steering wheel 11 direction toward the reaction force driving unit 20 direction to surround the inner tube support part 620.

The shock absorbing member 800 is fixed to the inner tube 600 by a fixing part 810 comprising a bolt, a rivet, or the like, at one end or the other end, and is formed in a shape bent from the steering wheel 11 direction toward the reaction force driving unit 20 direction to surround the inner tube support part 620.

The shock absorbing member 800 may be formed of a metal plate, and normally maintains a bent state, and during a frontal collision of the vehicle 1, moves rearward together with the inner tube 600, and a bent portion is unfolded by the inner tube support part 620.

As such, the shock absorbing member 800 moves together with the inner tube 600 during a collision of the vehicle 1, and absorbs a shock while being plastically deformed such that a bent portion is unfolded by the inner tube support part 620.

The electric steering column 10 according to the present embodiment absorbs impact energy during a plastic deformation process of the shock absorbing member 800 during a collision of the vehicle 1, and thus can effectively mitigate an impact transmitted to a driver.

Further, the electric steering column 10 according to the present embodiment further comprises a first sliding bushing 290 disposed between the mounting bracket 100 and the support bracket 200 and reducing friction during movement of the support bracket 200, and a second sliding bushing 530 disposed between the support bracket 200 and the outer tube 500 and reducing friction between the support bracket 200 and the outer tube 500 during a tilting operation The first sliding bushing 290 is disposed between the mounting bracket 100 and the support bracket 200, and reduces friction between the mounting bracket 100 and the support bracket 200 during front-rear movement of the support bracket 200.

The first sliding bushing 290 may be formed of a low-friction material, and is coupled to the support bracket 200 to reduce friction generated at a contact surface with the mounting bracket 100 if the support bracket 200 moves in the front-rear direction.

Such a first sliding bushing 290 may also perform a role of securing left-right rigidity of the support bracket 200.

The second sliding bushing 530 is disposed between the support bracket 200 and the outer tube 500, and reduces friction between the support bracket 200 and the outer tube 500 during a tilting operation.

The second sliding bushing 530 may be formed of a low-friction material, and is coupled to the outer tube 500 to reduce friction generated at a contact surface with the support bracket 200 if the outer tube 500 performs a tilting operation.

The electric steering column 10 of the present embodiment adjusts a position of the steering wheel 11 by operation of a first actuator 30, a second actuator 40, and a third actuator 50.

In the electric steering column 10 of the present embodiment, if the first actuator 30 rotates a first screw 32, the support bracket 200 moves to a rear side.

During movement of the support bracket 200, the first rolling contact member 254 of the first moving support part 250 contacts the second guide surface 134 while rolling thereon, and the second rolling contact member 264 of the second moving support part 260 contacts the third guide surface 136 while rolling thereon.

At this time, since the first rolling contact member 254 and the second rolling contact member 264 move in a rolling friction manner rather than a sliding friction manner, friction is significantly reduced.

In addition, the first friction reducing member 256 and the second friction reducing member 266 can reduce friction during rotation of the first rolling contact member 254 and the second rolling contact member 264.

As shown in FIG. 10, if the support bracket 200 moves toward a rear side, the outer tube 500, the inner tube 600, and the steering shaft 70 move together toward the rear side, and the steering wheel 11 moves in a direction away from a driver.

Further, in the electric steering column 10 of the present embodiment, if the first actuator 30 rotates the first screw 32 in an opposite direction, the support bracket 200 moves toward a front side.

During movement of the support bracket 200, since the first moving support part 250 and the second moving support part 260 move in a rolling friction manner, friction is significantly reduced.

As shown in FIG. 11, if the support bracket 200 moves toward the front side, the outer tube 500, the inner tube 600, and the steering shaft 70 move together toward the front side, so that the steering wheel 11 moves in a direction closer to the driver.

Further, if the second actuator 40 rotates the second screw 42 in one direction or an opposite direction, the tilting bracket 400 rotates by a predetermined angle 01 about a first coupling member 270.

According to the rotation of the tilting bracket 400, the outer tube 500, the inner tube 600, and the steering shaft 70 rotate together about a second coupling member 280, so that a vertical angle 02 of the steering wheel 11 can be adjusted.

Further, if the third actuator 50 rotates the third screw 52 in one direction or an opposite direction, the inner tube 600 protrudes from the outer tube 500 or is inserted into the outer tube 500.

That is, if the third screw 52 rotates in one direction, the inner tube 600 protrudes from the outer tube 500, and if the third screw 52 rotates in the opposite direction, the inner tube 600 is inserted into the outer tube 500.

Through this, additional forward-backward position adjustment of the steering wheel 11 is possible.

As such, in the present embodiment, as the support bracket 200 moves in a forward-backward direction and the inner tube 600 protrudes from the outer tube 500 or is inserted into the outer tube 500, a protrusion distance of the steering shaft 70 can be freely adjusted within a range from a minimum distance L1 to a maximum distance L2.

As described above, in the present embodiment, a forward-backward position and a vertical angle of the steering wheel 11 can be variously adjusted through operations of the first actuator 30, the second actuator 40, and the third actuator 50, and a position of the steering wheel 11 optimized for a driver's height or body type can be provided.

In addition, in the present embodiment, the first rolling contact member 254 contacts the second guide surface 134 while rolling thereon, and the second rolling contact member 264 contacts the third guide surface 136 while rolling thereon, so that friction generated during movement of the support bracket 200 can be minimized, a motor output of the first actuator 30 can be reduced, and operation noise can be reduced.

In addition, in the present embodiment, the first rolling contact member 254 is always supported in contact with the second guide surface 134, and the second rolling contact member 264 is always supported in contact with the third guide surface 136, so that vertical rigidity can be secured and vertical shaking of the support bracket 200 can be effectively prevented.

In addition, in the present embodiment, the first sliding bushing 290 is disposed between the mounting bracket 100 and the support bracket 200, so that lateral rigidity can be secured and a reduction in operating force can be prevented by preventing lateral movement.

As such, the electric steering column 10 according to the present embodiments can not only minimize motor output and reduce operating noise by reducing friction, but also improve movement stability of the steering wheel 11 by securing vertical and lateral rigidity.

The above description has been presented to enable any person skilled in the art to make and use the technical idea of the present disclosure, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the present disclosure. The above description and the accompanying drawings provide an example of the technical idea of the present disclosure for illustrative purposes only. That is, the disclosed embodiments are intended to illustrate the scope of the technical idea of the present disclosure.

What is claimed is:

1. An electric steering column comprising:
a mounting bracket fixed to a vehicle body, having an accommodating space formed therein, and having a guide part formed on one side or both sides of the accommodating space in a width direction and extending in a steering wheel direction or an opposite direction;
a support bracket contacting the guide part in a rolling friction manner, and installed in the accommodating space of the mounting bracket to be movable in the steering wheel direction or the opposite direction;
an outer tube supported by the support bracket, wherein an inner tube supporting rotation of a steering shaft is installed to be insertable into or protrudable from the outer tube; and
a tilting bracket installed between the support bracket and the outer tube to perform a tilting operation of a steering wheel.

2. The electric steering column of claim 1, wherein
the guide part comprises:
a first guide surface formed in the accommodating space toward the width direction;
a second guide surface formed on an upper side of the first guide surface toward an opposite direction to a vehicle body coupling side; and
a third guide surface formed on a lower side of the first guide surface to face the second guide surface, and
the support bracket comprises:
a first moving support part contacting the second guide surface while rolling thereon; and
a second moving support part contacting the third guide surface while rolling thereon.

3. The electric steering column of claim 2, wherein a plurality of the first moving support parts and a plurality of the second moving support parts are respectively formed on both sides of the support bracket in the width direction.

4. The electric steering column of claim 2, wherein the first moving support part comprises:
a first support member coupled to the support bracket; and
a first rolling contact member installed on the first support member, contacting the second guide surface, while rolling thereon.

5. The electric steering column of claim 4, wherein the first support member comprises:
a support shaft part rotatably supporting the first rolling contact member;
a separation prevention part extending from one side or the other side of the support shaft part in an enlarged-diameter shape, the separation prevention part preventing separation of the first rolling contact member; and
an insertion part extending in a reduced diameter shape on an opposite side of the support shaft part where the separation prevention part is formed, and coupled to the support bracket.

6. The electric steering column of claim 4, wherein the first moving support part further comprises:
a first friction reducing member disposed between the first rolling contact member and a separation prevention part of the first support member or between the first rolling contact member and the support bracket, and reducing friction during rotation of the first rolling contact member.

7. The electric steering column of claim 6, wherein the first friction reducing member is formed of a low-friction plastic material for reducing a friction coefficient of a contact surface during rotation of the first rolling contact member.

8. The electric steering column of claim 2, wherein the second moving support part comprises:
a second support member coupled to the support bracket; and
a second rolling contact member installed on the second support member, contacting the third guide surface, while rolling thereon.

9. The electric steering column of claim 8, wherein the second support member comprises:
a support shaft part rotatably supporting the second rolling contact member;
a separation prevention part extending in an expanded diameter shape on one side or the other side of the support shaft part, and preventing separation of the second rolling contact member; and
an insertion part extending in a reduced diameter shape on an opposite side of the support shaft part where the separation prevention part is formed, and coupled to the support bracket.

10. The electric steering column of claim 8, wherein the second moving support part further comprises:
a second friction reducing member disposed between the second rolling contact member and a separation prevention part of the second support member or between the second rolling contact member and the support bracket, and reducing friction during rotation of the second rolling contact member.

11. The electric steering column of claim 10, wherein the second friction reducing member is formed of a low-friction plastic material for reducing a friction coefficient of a contact surface during rotation of the second rolling contact member.

12. The electric steering column of claim 1, further comprising:
a first sliding bushing disposed between the mounting bracket and the support bracket to reduce friction during movement of the support bracket.

13. The electric steering column of claim 1, further comprising:
a second sliding bushing disposed between the support bracket and the outer tube to reduce friction between the support bracket and the outer tube during the tilting operation.

14. The electric steering column of claim 1, further comprising:
a first actuator coupled to the support bracket; and
a first screw rotated in one direction or an opposite direction by the first actuator, coupled to a first screw coupling part installed at an end of the mounting bracket, and moving the support bracket in the steering wheel direction or the opposite direction.

15. The electric steering column of claim 1, further comprising:
a second actuator coupled to the outer tube; and
a second screw rotated in one direction or an opposite direction by the second actuator, coupled to a second screw coupling part installed at an end of the tilting bracket to perform the tilting operation, and rotating the tilting bracket.

16. The electric steering column of claim 1, further comprising:
a third actuator coupled to the outer tube; and
a third screw rotated in one direction or an opposite direction by the third actuator, coupled to a third screw coupling part installed on the inner tube, and moving the inner tube in the steering wheel direction or the opposite direction.

17. The electric steering column of claim 16, further comprising:
an inner tube support part disposed inside the inner tube, coupled to the third screw coupling part disposed outside the inner tube, and fixing the inner tube to the third screw coupling part.

18. The electric steering column of claim 17, further comprising:
a shock absorbing member coupled to the inner tube, extending in the steering wheel direction, bent from the steering wheel direction toward an opposite direction to the steering wheel direction to surround the inner tube support part, and absorbing a shock while being plastically deformed such that a bent portion is unfolded by the inner tube support part by moving together with the inner tube during a collision of a vehicle.

19. A vehicle comprising:
an electric steering column rotatably supporting a steering wheel and comprising a reaction force driving unit generating a steering reaction force torque corresponding to manipulation of the steering wheel and providing the steering reaction force torque to a steering shaft rotating together with the steering wheel during rotation of the steering wheel;
a steering driving unit mechanically separated from the steering shaft and changing a steering angle of a wheel based on an electrical signal; and
a controller controlling the reaction force torque of the reaction force driving unit and a steering operation of the steering driving unit based on steering input information of the steering wheel and driving state information of the vehicle,
wherein the electric steering column comprises:
a mounting bracket fixed to a vehicle body, having an accommodating space formed therein, and having a guide part formed on one side or both sides of the accommodating space in a width direction and extending in a steering wheel direction or an opposite direction;
a support bracket contacting the guide part in a rolling friction manner, and installed in the accommodating space of the mounting bracket to be movable in the steering wheel direction or the opposite direction;
an outer tube supported by the support bracket, wherein an inner tube supporting rotation of the steering shaft is installed to be insertable into or protrudable from the outer tube; and
a tilting bracket installed between the support bracket and the outer tube to perform a tilting operation of the steering wheel.

20. The vehicle of claim 19, wherein the steering shaft comprises:
an input shaft rotatably supported by the inner tube and connected to the steering wheel;
an intermediate shaft rotatably supported by the outer tube and connected to the input shaft; and
a reaction force transmission shaft connected to the intermediate shaft via a torsion bar and transmitting an output of a reaction force motor to the intermediate shaft.
